(19) United States
(12) Patent Application Publication
(10) Pub. No.: US 2012/0118990 A1
(43) Pub. Date: May 17, 2012

(54) Personal defense spray gun and method

(76) Inventor: Albert Beever, III, Alpharetta, GA (US)

(21) Appl. No.: 11/786,040

(22) Filed: Apr. 9, 2007

Related U.S. Application Data
(60) Provisional application No. 60/790,253, filed on Apr. 7, 2006.
(60) Provisional application No. 60/875,050, filed on Dec. 15, 2006.

(51) Int. Cl. B05B 11/00; B23P 21/00

(52) U.S. Cl. 239/1; 239/302; 239/71; 239/72; 29/428

(57) ABSTRACT

A reusable personal defense spray gun and method which is easy to hold, aim, and actuate, and which includes an alarm for attracting assistance and/or stunning, disorienting, or disabling an attacker, especially in an emergency, includes a replaceable canister which is capable of dispensing fluid independent of its orientation.

### RELATED APPLICATIONS

The present United States Non-provisional Utility patent application is related to, and hereby claims priority to, and the benefit of, United States Provisional application entitled, “Personal Protection Apparatus,” having assigned Ser. No. 60/790,253, filed on behalf of Albert Beever III on 7 Apr. 2006, and United States Provisional Application entitled, “Personal Defense Spray Gun and Method,” having assigned Ser. No. 60/875,050, filed on behalf of Albert Beever III on 15 Dec. 2006.

### BACKGROUND OF THE INVENTION

1. Technical Field

The present invention relates generally to personal defense devices, and more specifically, to a personal defense spray gun.

2. Description of Related Art

Despite society's considerable efforts, violent crimes, such as robberies, car-jackings, kidnappings, rapes, and murders, remain a frequent occurrence in many cities, and pose a serious danger for citizens around the country. While governments struggle to find a solution to the violent crime problem, it is left to the individual to do his or her utmost to reduce the risk of becoming a victim.

Historically, various techniques have been employed to reduce the chance of being attacked, most of which primarily concerned threat avoidance. These techniques included the use of chaperones, posting of guards, imposition of curfews, seclusion in gated-communities, use of the “buddy system”, and other similar methods of discouraging a would-be attacker.

As time has shown, however, these techniques are sometimes impractical, and worse; sometimes ineffective. As a result, additional defensive techniques and devices have been implemented in order to repel an attacker when prevention techniques fail, ranging from hand-to-hand combat training to stun guns. One such defense that has proved effective at stopping an attacker has been pepper spray. When properly used, pepper spray can be an effective defensive weapon which is non-lethal and affordable.

Conventional pepper sprays are sometimes ineffective, however, due to being difficult to use properly in an attack situation due to poor design. Specifically, conventional pepper sprays are packaged in a tubular aerosol sprayer with a nozzle on the top, which is difficult to grasp and use in an emergency situation. Furthermore, the nozzle is typically a right angle spray nozzle, actuated by being depressed with the user's finger. Unfortunately, the user's finger often impedes or deflects the spray, or rotates the nozzle such that the spray misses the intended target. Additionally, the aerosol sprayer must be oriented vertically with the nozzle at the highest point or the sprayer will not work properly because propellant will escape through the nozzle when the pepper spray fluid drains away from the nozzle opening near the bottom of the tubular sprayer. Thus, conventional pepper sprayers are ineffective, or less effective, when used when to spray vertically upward, such as would be required by a victim lying prone with an attacker on top of them. Furthermore, conventional pepper sprays only incapacitate the attacker and completely fail to attract attention to the victim, which may increase the chance of obtaining assistance. Finally, conventional sprayers create a mist as the propellant mixes with the pepper spray. The mist can accidentally affect third persons or even the user as the mist is carried on the wind or as the mist hangs in the air of a closed space.

It is desirable, therefore, to provide a personal defense sprayer that is easy and comfortable to hold, aim, and operate, and that includes an alarm for attracting the attention of nearby persons for assistance.

### BRIEF SUMMARY OF THE INVENTION

Briefly described, in a preferred embodiment, the present invention overcomes the above-mentioned disadvantages and meets the recognized need for such a device by providing a body, a canister removably housed in the body comprising a rigid peripheral wall structure defining a sealed cavity therein and a nozzle disposed in an opening in the rigid peripheral wall structure and operably connected thereto such that the nozzle selectively allows or prevents fluid flow from the sealed cavity to an environment outside the canister, and a trigger movably connected to the body and operably connected to the nozzle for selective operation thereof.

According to its major aspects and broadly stated, the present invention in its preferred form is a personal defense spray gun comprising a fluid canister including a nozzle.

According to another aspect of the preferred embodiment, the canister is removably housed in a hinged canister housing of the body.

According to another aspect of the preferred embodiment, the canister includes a flexible liner disposed within the canister and sealed around the nozzle for containing a fluid irritant, a caustic fluid, or an attractant fluid.

According to another aspect of the preferred embodiment, a propellant is contained within the canister exterior to the flexible liner for propelling the fluid from the canister through the nozzle.

According to another aspect of the preferred embodiment, the nozzle is operably connected to, and actuated by, a trigger mounted on the body.

According to another aspect of the preferred embodiment, the nozzle allows fluid stored within the canister to spray out through the nozzle in a direction parallel to a longitudinal axis of the canister.

According to another aspect of the preferred embodiment, the body further includes a means, such as an LED or laser, for projecting light in a direction of the spray.

According to another aspect of the preferred embodiment, the body further includes means, such as a speaker, for creating an audible alarm signal.

According to another aspect of the preferred embodiment, the canister housing includes a canister ejector for at least partially ejecting the canister when the canister housing is opened.

According to another aspect of the preferred embodiment, the body further includes a power supply, such as a battery, operably connected to the light projection means and/or the alarm signal creating means.

According to another aspect of the preferred embodiment, the body further includes a safety switch, operably connected to the trigger, for selectively preventing operation thereof, thereby preventing discharge of fluid from the canister.

Accordingly, a feature and advantage of the present invention is its ability to accurately propel a stream of personal defense liquid or a hunting/fishing attractant.

Another feature and advantage of the present invention is its ability to facilitate aiming by mimicking the aiming mechanics of a firearm.

Yet another feature and advantage of the present invention is ability to provide a reusable personal defense sprayer.

Another feature and advantage of the present invention is its ability to attract the attention of nearby persons in an emergency situation.

Another feature and advantage of the present invention is its ability to cooperate with a canister of personal defense spray and propellant.

Another feature and advantage of the present invention is its ability to facilitate fast and easy removal and/or insertion of the canister.

Another feature and advantage of the present invention is its ability to eject a canister to further facilitate removal of the canister.

These and other objects, features, and advantages of the invention will become more apparent to those ordinarily skilled in the art after reading the following Detailed Description and Claims in light of the accompanying drawing Figures.

### BRIEF DESCRIPTION OF THE DRAWINGS

Accordingly, the present invention will be understood best through consideration of, and reference to, the following Figures, viewed in conjunction with the Detailed Description of the Preferred Embodiment referring thereto, in which like reference numbers throughout the various Figures designate like structure and in which:

FIG. 1 is a side view of a preferred embodiment of the invention.

FIG. 2 is a side view of the embodiment of FIG. 1 showing the canister housing in an open position.

FIG. 3 is an exploded view of the power supply.

FIG. 4 is a back view of the canister housing.

FIG. 5 is a front perspective view of a preferred embodiment of the invention.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the present invention illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose.

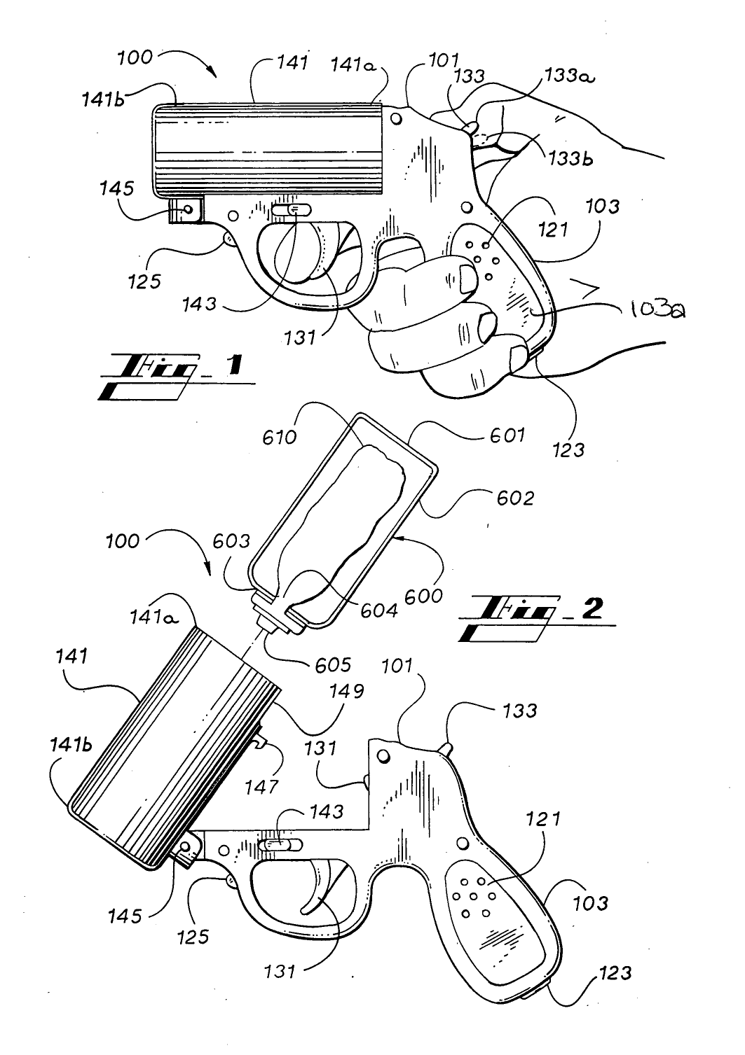

In that form of the preferred embodiment of the present invention chosen for purposes of illustration, FIG. 1 shows personal defense spray gun 100, preferably comprising a pistol shaped body 101. Preferably, body 101 comprises pistol grip portion 103. The shape of pistol grip portion 103 is preferably selected such that personal defense spray gun 100 is easy to hold. Pistol grip portion 103 preferably includes handgrips 103a for providing a high-friction surface, or the like, such that pistol grip portion 103 may be securely grasped by a user. The shape of body 101 is further preferably selected such that body 101 mimics the shape of a firearm such that aiming personal defense spray gun 100 is aided by a user's pervious experience with such firearms (or toys, such as a water pistol that mimic the shape and aiming mechanics of such firearms) and/or aided by the intuitive and ergonomic shape of body 101.

Pistol grip portion 103 preferably further comprises an audible alarm generating means, such as speaker 121, disposed therein. Speaker 121 is preferably configured to provide an audible alarm signal, and, thus, it will be appreciated by one skilled in the art that the location or other specifics of the audible alarm generating means may be altered so long as an audible alarm signal is generated that is capable of attracting the attention of nearby persons and alerting them that assistance is needed, such as in an emergency situation, or that is capable of stunning or disorienting an attacker. Pistol grip portion 103 preferably further comprises removable cap 123 for providing access to a power supply, such as one or more batteries 310 (FIG. 3). Batteries 310 (FIG. 3) are preferably operably connected to speaker 121 to provide power thereto, and are preferably further operably connected to lighting means, such as LED 125 to provide power thereto. LED 125 may optionally be replaced with high-intensity LED, laser, incandescent, fluorescent, neon, or other lighting means suitable for illuminating a target and/or stunning, disorienting, or visually impairing an attacker.

Body 101 preferably further comprises trigger 131 which is preferably operable by a user of personal defense spray gun 100 to discharge the personal defense spray as described in greater detail hereinbelow. Safety switch 133 is preferably operably connected to trigger 131 and is preferably movable between at least first safe position 133a and second fire position 133b, wherein trigger 131 is inoperable, at least to discharge a spray, when safety switch 133 is in first safe position 133a and is operable to discharge the personal defense spray when safety switch 133 is in second fire position 133b. It will be understood by one skilled in the art that the personal defense spray may be a pepper spray, such as oleoresin capsicum or the like, or may be any other suitable non-lethal defense spray, including gel materials. Likewise, other active sprays, such as animal repellants (e.g. bear repellant, shark repellant, citronella, or mosquito repellant), animal attractants (e.g. deer scents, fishing scents or chum), pest repellants, pest sprays, marking agents (e.g. dyes or paints), perfumes, deodorizers, fungicides, biocides, disinfectants, cleaning products, or other suitable liquid, gel, foam, or other agent or formula.

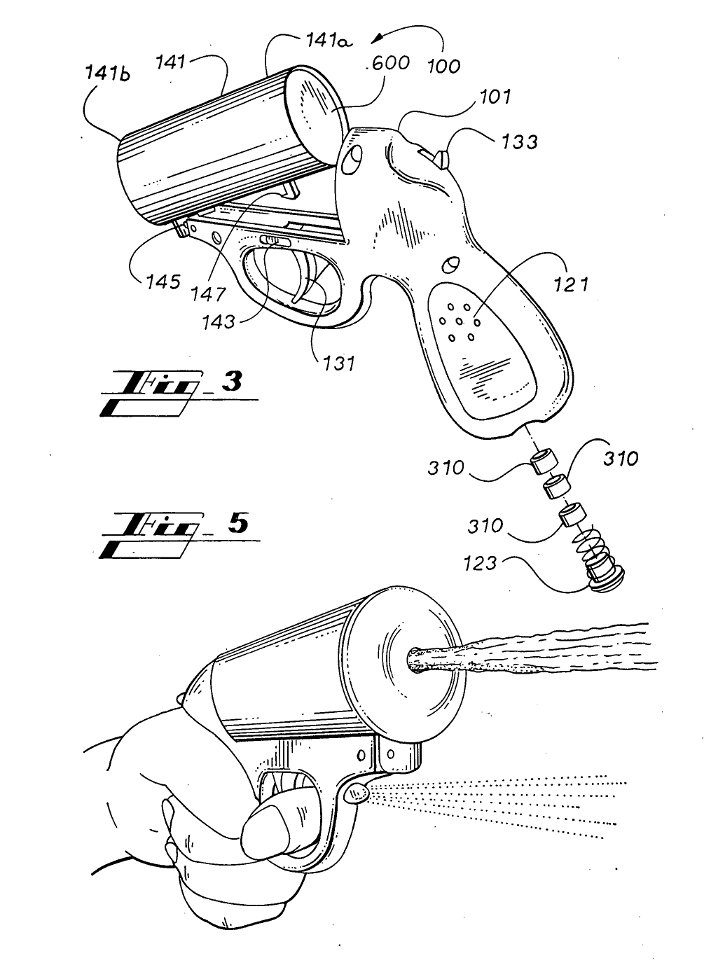

As is also shown in FIG. 1, personal defense spray gun 100 preferably includes canister housing 141 for receiving a canister containing a personal defense spray, such as canister 600 (FIG. 2). Body 101 preferably further includes biased (e.g. spring-biased) release button 143 operably connected to canister housing 141 for selectively retaining canister housing rear end 141a disposed proximate body 101, such that canister 600 is operably connected to trigger 131. Canister housing 141 is preferably hingedly attached to body 101 at canister housing front end 141b by a hinge element, such as pin 145. In operation, canister housing 141 is released from engagement with release button 143 by movement of release button 143. Upon such movement, canister housing rear end 141a is free to swing away from body 101 by rotating about pin 145.

Now referring to FIG. 2, canister housing 141 is shown in an open position, wherein canister housing rear end 141a has been swung away from body 101 about pin 145. Canister housing 141 preferably includes latch 147 protruding from a lower surface thereof configured for releasable operable engagement with release button 143 such that engagement of latch 147 with release button 143 ensures that canister housing 141 remains in a closed position, with canister housing rear end 141a disposed proximate body 101 and canister 600 operably connected to trigger 131. When canister housing 141 is in the open position, canister 600 may preferably be removed from canister housing 141 and be replaced. For this purpose, slot 149 is preferably included in canister housing 141 to provide access to a portion of canister 600, whereby a user can grip canister 600 and extract it from canister housing 141.

Now referring to FIG. 3, personal defense spray gun 100 preferably includes a power supply, such as batteries 310 disposed in pistol grip portion 103. According to a preferred embodiment, a plurality of batteries 310 are removably disposed in pistol grip portion 103 such that they are arranged in series connection and in electrical contact with leads of a circuit operably connected to speaker 121 and/or LED 125. Batteries 310 are preferably retained in such electrical contact by cap 123 which preferably includes spring 127 for biasing batteries 310 within pistol grip portion 103 and in electrical contact with the leads and with each other. Cap 123 is preferably threadably, or otherwise, connected to pistol grip portion 103, and is preferably removable therefrom in order to provide access to batteries 310 for replacement of batteries 310. As will be understood by one skilled in the art, alternative types of batteries and alternative arrangements are possible, and are within the scope of the invention.

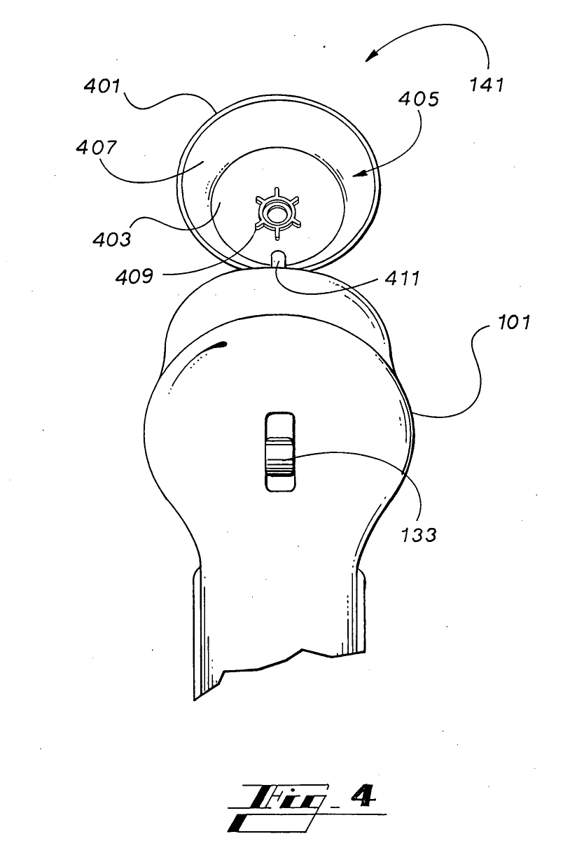

Now referring to FIG. 4, canister housing 141 is preferably comprises rigid hollow tube 401 with integral front wall 403 and rear opening 405, and is preferably configured in size and shape to receive and securely retain canister 600 therein. Front wall 403 preferably includes opening 407 disposed centrally therethrough for allowing passage of a stream of spray, such as a personal defense spray, pepper spray, oleoresin capsicum spray, or other caustic or irritant fluid, from canister 600 to an environment outside canister housing 141. Front wall 403 further optionally includes nozzle-receiver 409 for receiving and securely retaining nozzle 605 therein. Thus, when canister 600 is inserted into canister housing 141, canister 600 is preferably securely retained centrally therein with nozzle 605 in secure engagement with nozzle-receiver 409 such that fluid passing through nozzle 605 preferably passes through opening 407.

Ejector 411 is preferably mounted at a location of body 101 proximate canister housing front end 141b and projects into canister housing 141 proximate front wall 403. Ejector 411 preferably comprises a substantially resilient member and remains substantially stationary as canister housing 141 rotates about pin 145. Thus, when canister housing is in the closed position, ejector 411 is disposed between front wall 403 and canister 600 and does not interfere with the engagement of nozzle 605 and nozzle-receiver 409. As canister housing 141 is rotated about pin 145 to the open position, ejector 411 preferably engages canister 600 and preferably pushes canister 600 rearward through rear opening 405. Additionally, when a canister 600 is inserted in canister housing 141 in the open position, ejector 411 preferably prevents accidental actuation of nozzle 605 by being depressed upon contacting front wall 403. Finally, ejector 411 preferably biases canister 600 towards rear opening 405 such that when trigger 131 is not actuated, or when trigger 131 is released, nozzle 605 is not depressed and no spray leaves canister 600.

Now referring again to FIG. 2, canister 600 preferably comprises a sealed rigid peripheral wall structure including bottom 601, sidewall 602, and top 603 defining interior space 600a capable of containing fluid under pressure therein. Top 603 preferably includes opening 604 and nozzle 605 disposed therein and in sealed engagement therewith. Nozzle 605 is preferably selectively actuatable, by depressing nozzle 605, to selectively release a fluid contained within canister 600 under pressure. Canister 600 optionally includes flexible liner 610 disposed in interior space 600a and in sealed engagement with nozzle 605, such that a personal defense spray fluid may be hermetically contained within flexible liner 610, isolated from bottom 601, sidewall 602, and top 603, and isolated from a propellant fluid contained within interior space 600a. Use of flexible liner 610 allows for operation of personal defense spray gun 100 in any orientation because the propellant is separated from nozzle 605 by flexible liner 610, thereby preventing the propellant from escaping canister 600. Since the propellant cannot escape canister 600, personal defense spray fluid stored within flexible liner 610 will be forced out through nozzle 605 regardless of orientation. Additionally, flexible liner 610 preferably prevents mixing of the propellant fluid and the personal defense spray fluid such that when personal defense spray fluid is released through nozzle 605 misting is avoided. Preferably a liquid stream is propelled from canister 600 upon actuation of nozzle 605.

In operation, a user may preferably operate release button 143 thereby preferably disengaging canister housing 141 from body 101 at canister housing rear end 141a. The user may then preferably rotate canister housing 141 about pin 145 such that an interior of canister housing 141 is accessible through rear opening 405. The user may then preferably insert canister 600 into canister housing 141 with nozzle 605 disposed proximate opening 407 until top 603 engages ejector 411. The user may then preferably rotate canister housing 141 about pin 145 until latch 147 engages and is retained by release button 143. The user may then preferably move safety switch 133 from first safe position 133a to second fire position 133b and operate trigger 131. Operation of trigger 131 preferably pushes on bottom 601, thereby preferably causing nozzle 605 to be depressed, and, thus, activated, preferably releasing personal defense spray though nozzle 605 under pressure. When trigger 131 is released, ejector 411 preferably biases canister 600 toward rear opening 405 thereby allowing nozzle 605 to return to an inactive position.

Operation of trigger 131 may optionally complete a circuit, thereby providing electrical power to speaker 121 and/or LED 125. Alternatively, electrical power is supplied to speaker 121 and/or LED 125 only when trigger 131 is operated with safety switch 133 in first safe position 133a.

When canister 600 is empty of personal defense spray fluid, or when canister 600 is empty of propellant, canister 600 must be replaced. In order to replace canister 600, a user may preferably operate release button 143 thereby preferably disengaging canister housing 141 from body 101 at canister housing rear end 141a. The user may then preferably rotate canister housing 141 about pin 145 such that ejector 411 preferably pushes canister 600 rearward through rear opening 405. The user may then preferably remove canister 600 from canister housing 141 and insert a new canister 600. Once used, canister 600 may preferably be refilled with personal defense spray fluid, and reused.

According to an alternative embodiment, a test canister, structurally similar to canister 600, is provided. The test canister is preferably filled with water, optionally contained within a sealed liner similar to flexible liner 610, and propellant fluid under pressure. The user may initially insert the test canister in canister housing 141 and operate all of the features of personal defense spray gun 100 in order to become familiar with the operation thereof without the risk of releasing any personal defense spray fluid, which may cause damage to nearby objects or harm to nearby individuals, including the user. When the user has completed a test of the features of personal defense spray gun 100, the user may preferably then replace the test canister with canister 600 containing personal defense spray fluid.

Having, thus, described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A personal defense spray gun comprising:
a body;
a canister removably housed in said body comprising a rigid peripheral wall structure defining a sealed cavity therein and a nozzle disposed in an opening in said rigid peripheral wall structure and operably connected thereto such that said nozzle selectively allows or prevents fluid flow from said sealed cavity to an environment outside said canister; and
a trigger movably connected to said body and operably connected to said nozzle for selective operation thereof.

2. The personal defense spray gun of claim 1, wherein a propellant is disposed within said sealed cavity exterior to a flexible liner and stored therein under pressure.

3. The personal defense spray gun of claim 2, wherein said flexible liner is operably connected to said nozzle creating a sealed interior space hermetically sealed from said propellant, and wherein a fluid is disposed within said sealed interior space.

4. The personal defense spray gun of claim 1, further comprising a pistol grip.

5. The personal defense spray gun of claim 1, further comprising a safety switch operably connected to said trigger for selectively preventing and allowing operation of said trigger.

6. The personal defense spray gun of claim 1, further comprising a canister housing hingedly connected to said body, wherein said canister is removably housed in said canister housing.

7. The personal defense spray gun of claim 6, wherein said canister housing comprises a hole in a front end wall thereof.

8. The personal defense spray gun of claim 1, further comprising means for ejecting said canister from said body.

9. The personal defense spray gun of claim 1, further comprising means for shining a light in a direction of spray.

10. The personal defense spray gun of claim 1, further comprising means for creating an audible alarm signal.

11. The personal defense spray gun of claim 1, further comprising a power supply.

12. A personal defense spray system comprising:
a personal defense spray gun; and
a canister containing an active spray fluid, said canister removably operably connected to said personal defense spray gun.

13. The personal defense spray system of claim 12, further comprising a test canister containing an inert fluid.

14. The personal defense spray gun of claim 12, wherein said canister comprises an active defense spray fluid, a propellant, and a flexible divider therebetween.

15. The personal defense spray gun of claim 14, wherein said flexible divider separates said active defense spray fluid from said propellant.

16. A method of personal defense comprising the steps of:
obtaining a personal defense spray gun, said personal defense spray gun comprising an active repellant spray fluid and a propellant fluid;
releasing said active repellant spray fluid from said canister, thereby creating a repellant spray stream; and
directing said repellant spray stream at a desired target for defense,
whereby the target is at least one of repelled and incapacitated.

17. The method of claim 16, wherein said personal defense spray gun further comprises a canister, said canister containing said active repellant spray fluid and said propellant fluid.

18. The method of claim 17, wherein said active repellant spray fluid is separated from said propellant fluid by a flexible liner disposed within said canister.

19. A method of manufacturing a personal defense spray gun comprising the steps of:
forming a body including a canister receptacle and means for selectively actuating a canister disposed within said canister receptacle; and
inserting a canister into said canister receptacle, said canister containing an active spray fluid, and a propellant fluid.

20. The method of claim 19, wherein said active spray fluid is separated from said propellant fluid by a divider disposed within said canister.

21. The method of claim 20, further comprising the step of filling at least a portion of said canister with said active spray fluid, said at least a portion of said canister being separate from a portion of said canister containing said propellant fluid.

22. The method of claim 21, wherein said filling step is performed after use of said container, wherein at least some active spray fluid is dispensed from said canister during said use, such that said filling step comprises re-filling said canister.

23. A fluid attractant spray gun comprising:
a body;
a canister removably housed in said body, said canister containing an attractant fluid under pressure; and
a trigger movably connected to said body and operably connected to said nozzle for selective operation thereof.

24. A method of using a personal defense spray gun comprising the steps of:
loading a test canister in the personal defense spray gun;
spraying a first test fluid using the personal defense spray gun;
replacing the test canister with an active spray canister; and
spraying an active fluid using the personal defense spray gun.
